(19) United States
(12) Patent Application Publication
(10) Pub. No.: US 2007/0251116 A1
(43) Pub. Date: Nov. 1, 2007

(54) Nitrogen cabinet with ID management and gas charging means

(75) Inventors: Yuan-Yu Huang, Taoyuan City (TW); Chien-Rong Huang, Hsinchu City (TW); Ying-Tsao Lin, Hsinchu City (TW); Chun-Hsiu Lin, Hsinchu City (TW)

Correspondence Address: BACON & THOMAS, PLLC, 625 SLATERS LANE, FOURTH FLOOR, ALEXANDRIA, VA, 22314, US

(73) Assignee: Fortrend Taiwan Scientific Corp., Hsinchu City (TW)

(21) Appl. No.: 11/636,485

(22) Filed: Dec. 11, 2006

(30) Foreign Application Priority Data
Apr. 28, 2006 (TW) 095207256

(51) Int. Cl. F26B 25/18; F26B 25/06; B65B 3/04

(52) U.S. Cl. 34/202; 141/237; 34/192

(57) ABSTRACT

A nitrogen cabinet is disclosed to include at least one cabinet body having a door and a nitrogen inlet connected to a nitrogen supplier, multiple shelves mounted inside the cabinet body and defining multiple storage spaces, multiple containers mounted in storage spaces, each container having at least one gas charging port and an identification device, and multiple gas-charging units mounted inside the cabinet body and respectively connected to the nitrogen inlet for charging the containers with nitrogen. Thus, the nitrogen cabinet combines the functions of storage, charging, management, identification, and tracing of the containers, thereby lowering the chance of oxidation or contamination of storage items in the containers and effectively controlling real-time inventory data to improve product yield rate.

### BACKGROUND OF THE INVENTION

1. Field of the Invention

The present invention relates to nitrogen cabinets and more particularly, to such a nitrogen cabinet that is suitable for storing mask/reticle SMIF (Standard Mechanical Interface) pod or wafer SMIF pod and that provides storage container ID management and nitrogen charging control functions.

2. Description of Related Art

Regular semiconductor devices such as masks/reticles and wafers are commonly stored in storage containers, such as mask/reticle SMIF pod and wafer SMIF pod, under a non-oxidized or a non-moisture gas environment to prevent contamination or oxidation. Argon gas, nitrogen gas, clean dry air (CDA) can be used. Typically, a purified nitrogen gas is used to protect the mask/reticle or wafer. However, semiconductor device storage containers cannot be completely sealed. When a wafer SMIF pod is kept under the atmosphere for 6 hours, its internal oxygen concentration will rise from 0% to 6%. Therefore, the storage time of a wafer SMIF pod when charged with nitrogen is allowed for only about 18˜24 hours. For a mask/reticle SMIF pod, the storage time is relatively shorter, or about 6 hours only. Therefore, wafer SMIF pods and mask/reticle SMIF pods must be regularly charged with nitrogen to ensure purity of wafer and mask/reticle storage environment.

Conventionally, wafer SMIF pods and mask/reticle SMIF pods=are stored in a nitrogen cabinet to extend nitrogen charging time interval. In a conventional nitrogen cabinet, the cabinet body has a gas filling port connected to a nitrogen cylinder for the filling of nitrogen irregularly.

Further, conventional nitrogen cabinets simply provide a nitrogen environment without providing a pod charging function to charge storage wafer SMIF pods or mask/reticle SMIF pods with nitrogen. When wishing to charge storage wafer SMIF pods or mask/reticle SMIF pods=with nitrogen, the operator must open the cabinet body, and then take the storage wafer SMIF pods or mask/reticle SMIF pods out of the nitrogen cabinet, and then charge the wafer SMIF pods or mask/reticle SMIF pods with nitrogen outside the nitrogen cabinet, and then close the nitrogen cabinet after the wafer SMIF pods or mask/reticle SMIF pods have been charged with nitrogen and put back to the inside of the nitrogen cabinet. It is inconvenient for operation or miss-processing if nitrogen cabinet and nitrogen charger are located in different place. Each time the nitrogen cabinet is opened, it must be charged with nitrogen again, wasting much resource.

Further, conventional nitrogen cabinets are simply for keeping storage items clean without providing a managing or tracing function. When a big number of wafer SMIF pods or mask/reticle SMIF pods are stored in a nitrogen cabinet or wafer SMIF pods or mask/reticle SMIF pods have been stored in a nitrogen cabinet for long, an inventory mistake may happen, resulting in a management problem and affecting the product yield rate. In conclusion, conventional nitrogen cabinets that provide only a nitrogen environment for keeping storage items clean are still not satisfactory in lot management requirement of a modern wafer factory.

Therefore, it is desirable to provide a nitrogen cabinet that eliminates the aforesaid problems.

### SUMMARY OF THE INVENTION

The present invention has been accomplished under the circumstances in view. According to the present invention, the nitrogen cabinet comprises at least one cabinet body, at least one shelf, a plurality of containers, and at least one gas-charging unit. The cabinet body has a door, and a nitrogen inlet connected to a nitrogen supplier. The at least one shelf is respectively mounted inside the cabinet body, defining a plurality of storage spaces. The containers are mounted in the storage spaces inside the cabinet body, each comprising at least one gas charging port and at least one identification device. The at least one gas-charging unit is mounted inside the cabinet body and respectively connected to the nitrogen inlet for charging the containers with nitrogen.

Thus, the nitrogen cabinet of the invention combines the functions of storage, charging, management, identification, and tracing of the containers, thereby lowering the chance of oxidation of storage items in the containers and effectively controlling real-time inventory data to improve product yield rate.

Further, the containers can be wafer SMIF pods or mask/reticle SMIF pods to provide storage wafers or masks/reticles with a nitrogen environment, preventing oxidation or contamination of storage wafers or masks/reticles.

The nitrogen cabinet further comprises a control unit mounted inside the cabinet body and adapted to manage the containers. The control unit has a keyboard or any of a variety of equivalent input devices for easy operation by the operator to check container data, to set nitrogen cabinet system settings, and to troubleshoot problems. The control unit preferably has a connection port, for example, internet or RS-232C networks for the connection of an external computer or other control unit. By means of the connection port, multiple nitrogen cabinets can be linked to facilitate management of multiple containers at different locations. The control unit may be used with sensor means mounted on the cabinet door of the cabinet body and/or the containers so that when the cabinet door and/or the containers are not closed, the control unit controls not to fill the cabinet body and/or charge the containers with nitrogen.

Further, the identification device can be an 1-dimensional or 2-dimensional barcode, radio frequency identification (RF ID) tag, or other equivalent identification means convenient for read and/or write of the data of process lot number, storing time, nitrogen charging time and nitrogen pressure of every container.

The nitrogen cabinet further comprises a reader mounted on the cabinet body or storage spaces and adapted to read the data of the identification device of every container, thereby facilitating management of containers.

The nitrogen cabinet further comprises a display mounted outside the cabinet body adapted to display the data of process lot number, storing time, nitrogen charging time and nitrogen pressure of each container and the inside pressure of the cabinet body.

The nitrogen cabinet further comprises an ion bar mounted inside the cabinet body and adapted to eliminate statistic electricity.

The nitrogen cabinet further comprises a signal light mounted outside the cabinet body and adapted to indicate operation status of the nitrogen cabinet. Alternatively, a buzzer may be mounted outside the cabinet body to provide an audio warning signal. For example, when the operator is going to open the door of the cabinet body before exhausting nitrogen out of the cabinet body, the buzzer will buzz and the signal light will provide a red light, reminding the operator to exhaust nitrogen out of the cabinet body before opening the cabinet body.

The nitrogen cabinet further comprises a cabinet pressure gage and/or a flow meter mounted outside the cabinet body and adapted to measure and indicate nitrogen pressure inside the cabinet body and/or to measure and indicate the flowrate of nitrogen of the at least one gas-charging unit.

The cabinet pressure gage and/or the flow meter may be used with a control unit that allow setting of upper and lower pressure limits and/or charging flowrate and volume. When the pressure inside the cabinet body is below the set lower limit level, the control unit automatically opens the at least one gas-filling unit to fill nitrogen. On the contrary, when the inside pressure of the cabinet body surpassed the set upper limit level, the control unit automatically closes the at least one gas-filling unit or start exhausting. The cabinet nitrogen filling or exhausting operation can be performed at a regular speed, or at a high speed, i.e., the nitrogen cabinet provides a regular nitrogen filling mode, a regular nitrogen exhausting mode, a rapid nitrogen filling mode and a rapid nitrogen exhausting mode.

The nitrogen cabinet further comprises at least one charging button mounted outside the cabinet body and adapted to open the at least one charging unit for charging the containers with nitrogen, a nitrogen-recycling unit connected to a nitrogen outlet on the cabinet body, and an exhausting button mounted outside the cabinet body and adapted to open the nitrogen-recycling unit for receiving nitrogen exhausted out of the cabinet body.

The nitrogen cabinet further comprises an emergency button mounted outside the cabinet body and manually operable to let nitrogen be exhausted out of the cabinet body rapidly.

The nitrogen cabinet further comprises a high efficiency particulate air (HEPA) filter or an ultra low penetration air (ULPA) filter installed in the nitrogen inlet to remove particles from nitrogen passing from the nitrogen supplier to the cabinet body to ensure purity of nitrogen in the containers and the cabinet body.

The nitrogen cabinet further comprises a charging pressure gage and/or a system pressure gage mounted outside the cabinet body and adapted to measure and indicate the pressure of charging nitrogen and/or the system pressure of the nitrogen supplier.

### BRIEF DESCRIPTION OF THE DRAWINGS

FIG. 1 is an elevational view of a nitrogen cabinet in accordance with the present invention, showing the cabinet door opened.

FIG. 2 is an elevational view of the nitrogen cabinet in accordance with the present invention, showing the cabinet door closed.

FIG. 3 is a front view of the nitrogen cabinet in accordance with the present invention.

FIG. 4 is an elevational view of a material container for use in the nitrogen cabinet in accordance with the present invention.

### DETAILED DESCRIPTION OF THE PREFERRED EMBODIMENT

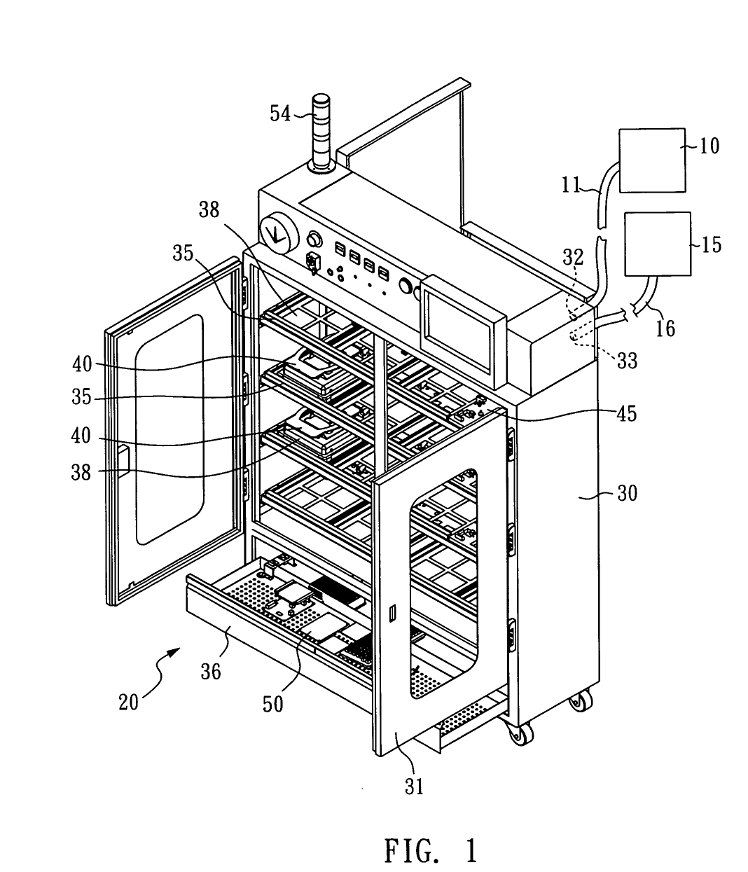

Referring to FIGS. 1 through 3, a nitrogen cabinet 20 in accordance with the present invention is shown comprised of a cabinet body 30, four shelves 35, a HEPA (High efficiency Particulate Air) filter 37, three gas-charging units 45, a control unit 50, a reader 44, a display 52, an ion bar 53, a signal light 54, a cabinet pressure gage 56, a flow meter 57, a charging button 58, an exhausting button 59, an emergency button 60, a charging pressure gage 61, and a system pressure gage 62.

As shown in FIG. 1, the cabinet body 30 has a door 31 provided at its front side as well as its back side, a drawer 36 provided at its front side beneath the corresponding door 31, and a nitrogen inlet 32 and a nitrogen outlet 33 provided at its top side and respectively connected to a nitrogen supplier 10 through an inlet pipe 11 and a nitrogen-recycling unit 15 through an outlet pipe 16. The HEPA filter 37 is installed in the nitrogen inlet 32 to remove particles from nitrogen passing from the nitrogen supplier 10 to the cabinet body 30, ensuring purity of containers 40 and nitrogen in the cabinet body 30. The four shelves 35 are mounted inside the cabinet body 30, thereby defining sixteen storage spaces 38 for holding containers 40. The three gas-charging units 45 are mounted inside the cabinet body 30 and respectively connected to the nitrogen inlet 32 for filling the nitrogen cabinet 20 and charging containers 40 with nitrogen. According to the present preferred embodiment, two containers 40 are stored in the storage spaces 38 inside the cabinet body 30.

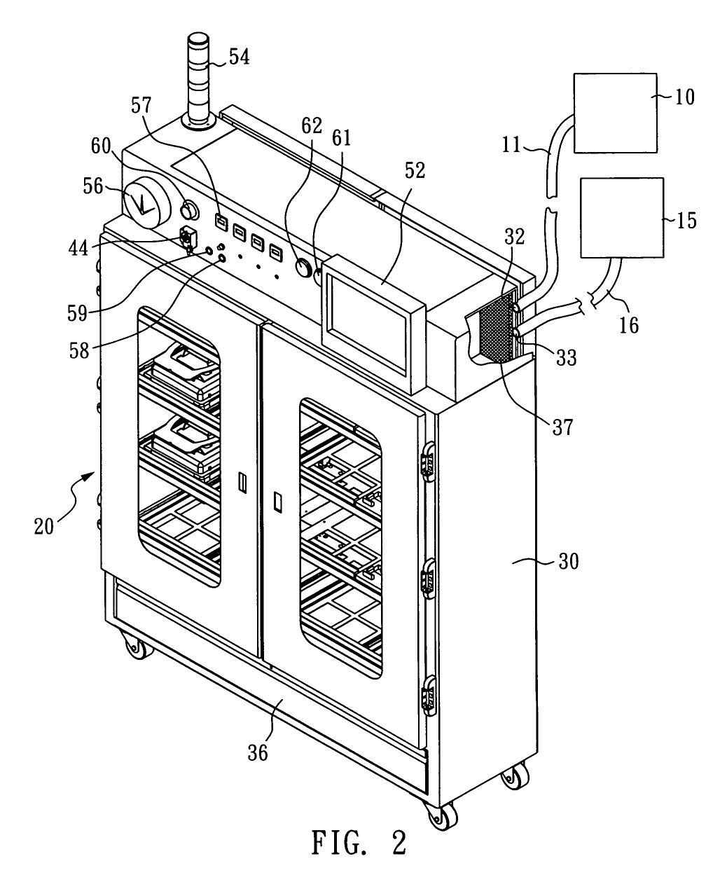

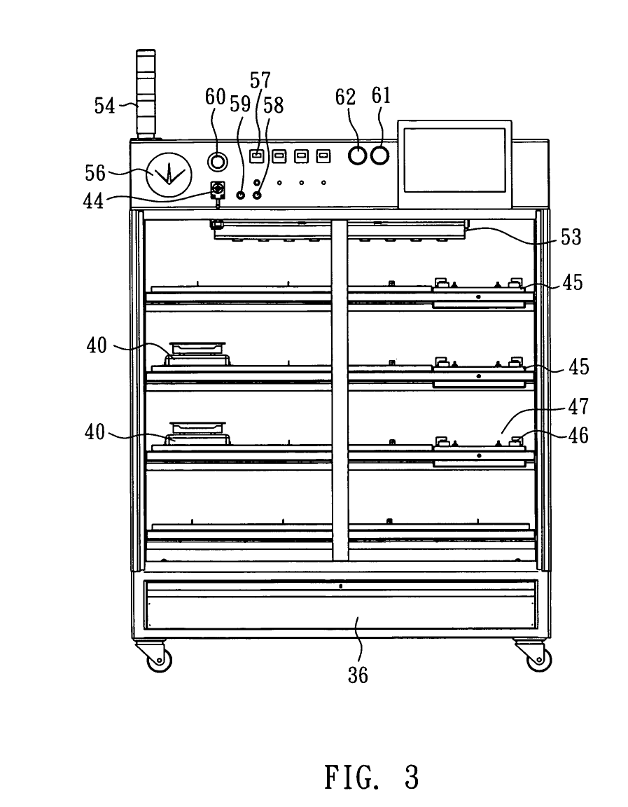

Referring to FIGS. 2 and 3, the ion bar 53 is mounted in the cabinet body 30, and adapted to neutralize positive and negative ions, thereby removing static electricity from the inside space of the cabinet body 30. The control unit 50 is installed in the drawer 36 of the cabinet body 30, and adapted to manage storage information of the containers 40 in the cabinet body 30 and the system setting in the cabinet body 30 as well as troubleshooting. Further, each gas-charging unit 45 has four clamps 46 for securing the containers 40, preventing vibration of the containers 40 when charging the containers 40 with nitrogen.

Referring to FIG. 2 again, the reader 44, the display 52, the signal light 54, the cabinet pressure gage 56, the flow meter 57, the charging pressure gage 61 and the system pressure gage 62 are mounted on the outside wall of the cabinet body 30, convenient for operation by the operator. The reader 44 reads in data of the process lot number of the ID device 42 on every container 40 and the storing time, nitrogen charging time and nitrogen pressure of every container 40. The display 52 displays the data read by the reader 44 as well as the nitrogen pressure in the cabinet body 30. The signal light 54 is adapted to indicate different operation status, reminding the operator of the situations. The cabinet pressure gage 56 is adapted to measure the nitrogen pressure in the cabinet body 30. The charging pressure gage 61 is adapted to measure the charging pressure of the gas-charging units 45. The system pressure gage 62 is adapted to measure the system pressure of the nitrogen supplier 10. Further, the flow meter 57 is adapted to measure the charging flowrate of nitrogen of the gas-charging units 45.

Further, the charging button 58, the exhausting button 59 and the emergency button 60 are mounted on the outside wall of the cabinet body 30 so that the operator can operate these buttons conveniently by hand. The charging button 58 is manually operable to open the charging units 45. The exhausting button 59 is manually operable to open the nitrogen-recycling unit 15. The emergency button 60 is manually operable to open the nitrogen-recycling unit 15 and to start an exhausting mode and to empty nitrogen out of the cabinet body 30.

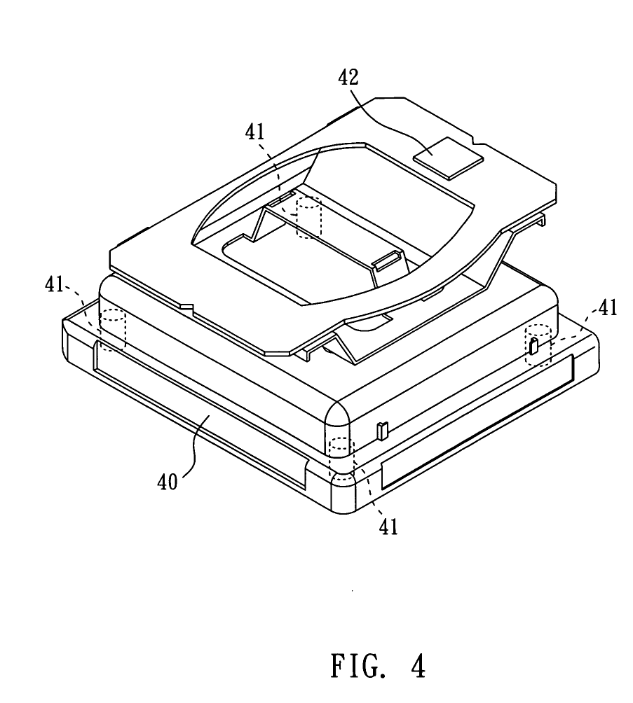

Referring to FIG. 4, each container 40 has four charging ports 41, and an ID (Identification) device 42. The four charging ports 41 are provided at the bottom side of the container 40 corresponding to the charging holes 47 of the gas-charging units 45. The ID (Identification) device 42 is mounted on the topside or front-side of the container 40 for easy reading by the reader 44. The containers 40 can be wafer SMIF pods, mask/reticle SMIF pods, or the like. The ID device 42 can be a RFID (Radio Frequency Identification) tag or ID/2D barcode. According to the present preferred embodiment, the containers 40 are mask/reticle SMIF pods for storing masks, and the ID device 42 is a RFID tag, allowing read and write to facilitate access to all data of every container 40 regarding process lot number, storing time, nitrogen charging time, and nitrogen pressure.

Although the present invention has been explained in relation to its preferred embodiments, it is to be understood that many other possible modifications and variations can be made without departing from the spirit and scope of the invention as hereinafter claimed.

What is claimed is:

1. A nitrogen cabinet comprising:
at least one cabinet body, said cabinet body comprising a door, and a nitrogen inlet connected to a nitrogen supplier;
at least one shelf respectively mounted inside said cabinet body, said at least one shelf defining a plurality of storage spaces;
a plurality of containers each mounted in one of said storage spaces inside said cabinet body, said containers each comprising at least one gas charging port and an identification device; and
at least one gas-charging unit mounted inside said cabinet body and respectively connected to said nitrogen inlet for charging said containers with nitrogen.

2. The nitrogen cabinet as claimed in claim 1, further comprising a control unit mounted inside said cabinet body and adapted to manage said containers.

3. The nitrogen cabinet as claimed in claim 1, wherein said containers include at least one of wafer SMIF pods and mask/reticle SMIF pods.

4. The nitrogen cabinet as claimed in claim 1, wherein said identification device is selected from 1-dimensional barcode, 2-dimensional barcode and radio frequency identification tag.

5. The nitrogen cabinet as claimed in claim 1, further comprising a reader mounted on said cabinet body or said storage spaces and adapted to read the data of said identification device.

6. The nitrogen cabinet as claimed in claim 1, further comprising a display mounted outside said cabinet body adapted to display the data of said containers.

7. The nitrogen cabinet as claimed in claim 1, further comprising an ion bar mounted inside said cabinet body and adapted to eliminate statistic electricity.

8. The nitrogen cabinet as claimed in claim 1, further comprising a signal light mounted outside said cabinet body and adapted to indicate operation status of the nitrogen cabinet.

9. The nitrogen cabinet as claimed in claim 1, further comprising a cabinet pressure gage mounted outside said cabinet body and adapted to measure and indicate nitrogen pressure inside said cabinet body.

10. The nitrogen cabinet as claimed in claim 1, further comprising at least one flow meter and at least one pressure gage mounted outside said cabinet body and adapted to measure and indicate the flow rate and the pressure of nitrogen of said at least one gas-charging unit.

11. The nitrogen cabinet as claimed in claim 1, further comprising at least one charging button mounted outside said cabinet body and adapted to open said at least one gas-charging unit.

12. The nitrogen cabinet as claimed in claim 1, further comprising a nitrogen-recycling unit connected to a nitrogen outlet formed on said cabinet body, and an exhausting button mounted outside said cabinet body and adapted to open said nitrogen-recycling unit for receiving nitrogen from said cabinet body.

13. The nitrogen cabinet as claimed in claim 1, further comprising an emergency button mounted outside said cabinet body and operable for exhausting of nitrogen out of said cabinet body.

14. The nitrogen cabinet as claimed in claim 1, further comprising a high efficiency particulate air filter installed in said nitrogen inlet to remove particles from nitrogen passing from said nitrogen supplier to said cabinet body.
